(19) United States
(12) Patent Application Publication
(10) Pub. No.: US 2016/0165128 A1
(43) Pub. Date: Jun. 9, 2016

(54) CAPTURING AND SENDING IMAGES AND VIDEOS BASED ON A SINGLE USER INTERACTION WITH A USER INTERFACE ELEMENT

(71) Applicant: Facebook, Inc., Menlo Park, CA (US)

(72) Inventors: Samantha P. Krug, Menlo Park, CA (US); Ryan Jacob Gomba, San Francisco, CA (US); Peter Xiu Deng, Los Altos Hills, CA (US)

(21) Appl. No.: 14/561,733

(22) Filed: Dec. 5, 2014

(51) Int. Cl. H04N 5/232; G06F 3/0482; H04L 12/58; G06F 3/0484; G06F 3/0486; G06F 3/0488; H04N 1/00; G06F 3/0481

(52) U.S. Cl. CPC H04N 5/23216; H04N 5/23293; H04N 1/00209; G06F 3/0482; G06F 3/04817; G06F 3/04842; G06F 3/0486; G06F 3/04886; H04L 51/043; H04L 51/10

(57) ABSTRACT

A user interacts with a messaging application on a client device to capture and send images to contacts or connections of the user, with a single user interaction. The messaging application installed on the client device, presents to the user a user interface. The user interface includes a camera view and a face tray including contact icons. On receiving a single user interaction with a contact icon in the face tray, the messaging application captures an image including the current camera view presented to the user, and sends the captured image to the contact represented by the contact icon. In another example, the messaging application may receive a single user interaction with a contact icon for a threshold period of time, and may capture a video for the threshold period of time, and send the captured video to the contact.

### BACKGROUND

This invention relates generally to a messaging application, and more specifically to capturing and sending images, video or other media content from a client device to a selected recipient.

Users of client devices often use one or more messaging applications to send messages to other users associated with client devices. The messages include a variety of content ranging from text to images to videos. However, the messaging applications often provide the user with a cumbersome interface that requires users to perform multiple user interactions with multiple user interface elements or icons in order to capture images or videos and send the captured images or videos to a contact or connection associated with the user. If a user simply wishes to quickly capture a moment with an image or video and send to another user, typically the user must click through multiple interfaces to take the image/video, select the user to whom it will be sent, and initiate the sending process. It would instead be beneficial for a messaging application to present a user interface to a user allowing the user to send images and videos to other users based on as few as possible user interactions with one or more of the user interface elements.

### SUMMARY

A messaging application on a client device allows a user to select one or more recipients (e.g., contacts of the user) and to capture and send an image, video, or other media content to the selected recipients, with a single user interaction. The single user interaction may comprise, for example, a single click or tap on an icon or link that is associated with the selected recipient. In this manner, the user can quickly capture a moment and send an image or video to another user with a single tap. The messaging application installed on the client device, when executed on the client device, presents to the user a user interface. In one embodiment, the user interface includes a camera view and a “face tray” including one or more contact icons and, in some embodiments, a page icon. The “face tray” comprises a list or tray of contact icons that can be presented as “faces” or photos of the user's contacts. The user interface may also include other elements, such as a switch camera icon, a gear icon and a text icon.

The camera view presents the current view viewed by the camera on the client device to the user. In one example, the messaging application accesses the camera via an API and receives a video stream of the view currently viewed by the camera. The messaging application may simultaneously present the received video stream to the user via the camera view. The face tray can be presented as an overlay on the camera view and includes contact icons representing one or more contacts associated with the user. The contact icons can include an image and text identifying the contact, such as a name. The face tray may also include a page icon representing a page. Each page includes one or more contact icons. At any given time one page including a set of contact icons can be displayed to the user via the face tray of the user interface. In some embodiments, the user can slide or swipe the face tray back and forth across the screen to view additional contacts.

On receiving a single user interaction with a contact icon in the face tray, the messaging application captures an image including the current camera view presented to the user, and sends the captured image to the contact represented by the contact icon. In one example, the messaging application captures the image by retrieving the frame of the received video stream associated with the time value at which the user interaction with the contact icon was received. In another example, the messaging application may receive a single user interaction with a contact icon for a threshold period of time, such as the user tapping and holding the portion of the face tray including the contact icon. The messaging application may then capture a video for a portion of time corresponding to the threshold period of time, the video including the camera view presented to the user for the threshold period of time, and may send the captured video to the contact represented by the contact icon interacted with by the user.

In one embodiment, the messaging application automatically populates the face tray with contact icons associated with one or more contacts associated with the user. Alternatively, the user may select one or more contacts to include in the face tray of the user interface via a separate user interface presented to the user.

### BRIEF DESCRIPTION OF THE DRAWINGS

FIG. 1 is a block diagram of a system environment in which a client device and a messaging server operates, in accordance with an embodiment of the invention.

FIG. 2 is a block diagram of a client device, in accordance with an embodiment of the invention.

FIG. 3A shows an example user interface presented to the user by the messaging application, in accordance with an embodiment of the invention.

FIG. 3B shows an example user interface for selecting one or more contacts to include in the face tray, in accordance with an embodiment of the invention.

FIG. 3C shows an example user interface for entering text to be overlayed over the camera view presented to the user, in accordance with an embodiment of the invention.

FIG. 3D shows example user interactions received from the user with respect to the face tray, in accordance with an embodiment of the invention.

FIG. 4 is a flowchart illustrating a method for capturing images via a user interface, in accordance with an embodiment of the invention.

FIG. 5 is a flowchart illustrating a method for identifying and selecting contacts to include in the face tray of the user interface of the messaging application, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

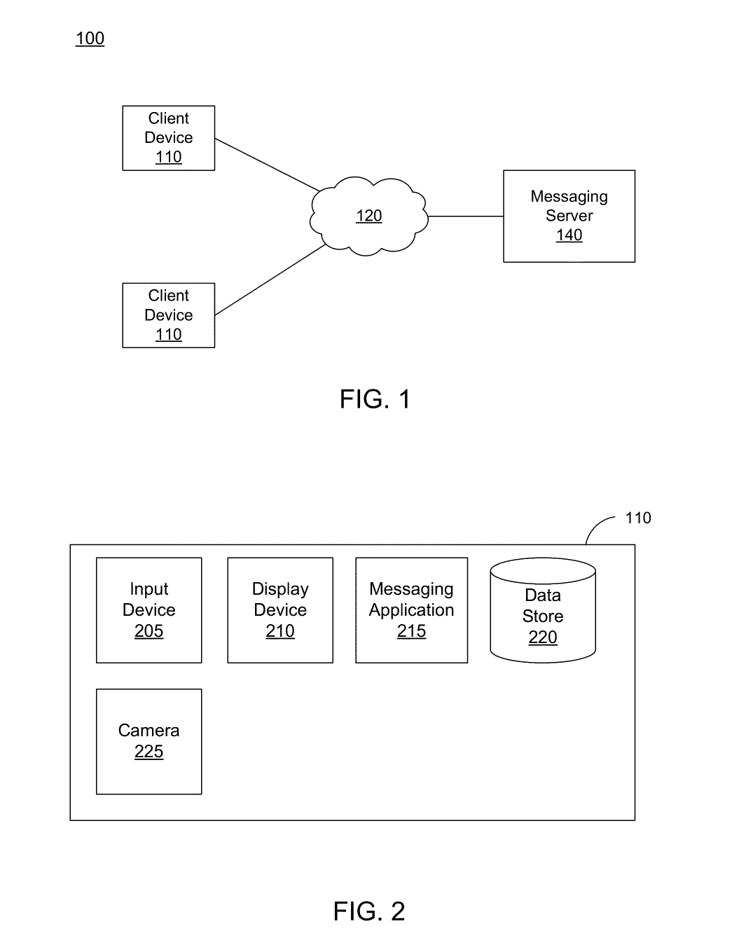

FIG. 1 is a high level block diagram of a system environment for a messaging server 140. The system environment 100 shown by FIG. 1 comprises one or more client devices 110, a network 120, and a messaging server 140. In alternative configurations, different and/or additional components may be included in the system environment 100. The embodiments described herein can be adapted to online systems that are not messaging servers or messaging systems.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes a messaging application allowing a user of the client device 110 to interact with users of other client devices 110, by sending them images for example. For example, a client device 110 executes a messaging application to enable interaction between the client device 110, the messaging server 140, and other client devices 110 via the network 120.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language

(XML). In some embodiments, all or some of the communication links of the network 120 may be encrypted using any suitable technique or techniques.

The messaging server 140 manages the communication of messages from one client device 110 to another client device 110. In one embodiment, the messaging server 140 receives messages from a messaging application executing on a client device and pushes the messages to other messaging application installed or executing on other client devices 110. The messaging server 140 may also store the messages permanently or temporarily. Further, the messaging server may also store information associated with a user of a messaging application executing on the user's client device 110. For example, the messaging server 140 may store information identifying the user such as a name or a phone number, contacts associated with the user and contact information such as names and phone number associated with the contacts, or the number of times and the communications between a user and one or more contacts using messaging applications executing on the respective client devices 110.

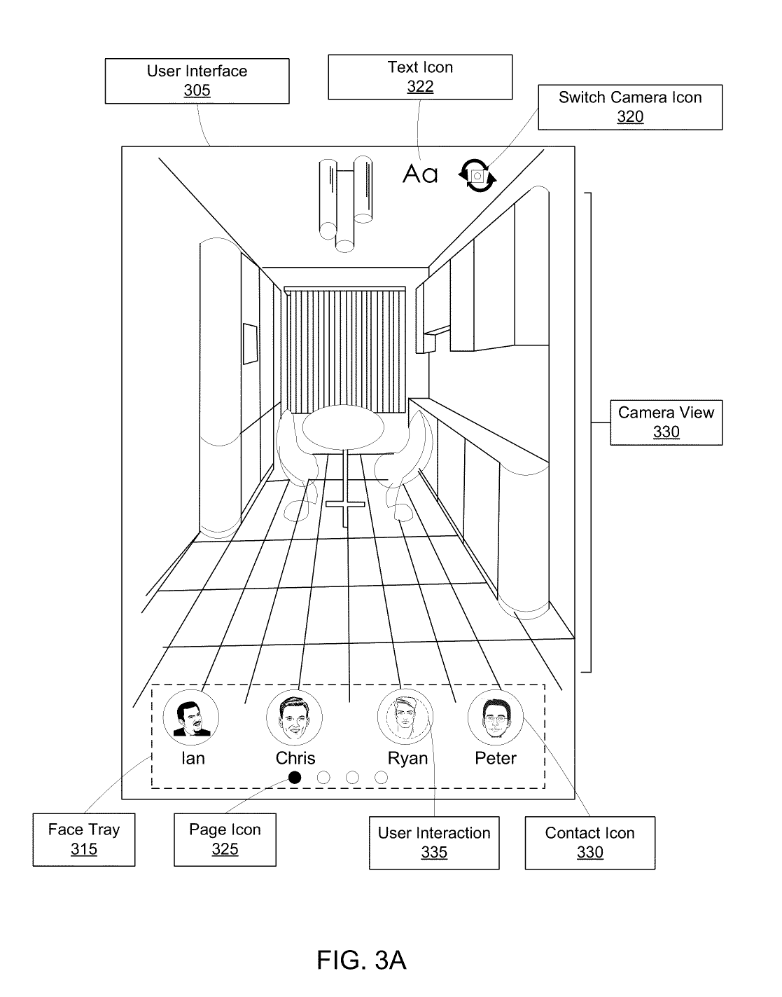

FIG. 2 is an example block diagram of a client device 110. The client device 110 shown in FIG. 2 includes an input device 205, a display device 210, a messaging application 215, a data store 220, and a camera 225. In other embodiments, the client device 110 may include additional, fewer, or different components for various applications. Conventional components such as a processor, memory including an operating system, network devices, and the like are not shown so as to not obscure the details of the system architecture.

A display device 210 included in the client device 110 presents content to a user of the client device 110. Examples of the display device 210 include a liquid crystal display (LCD), an organic light emitting diode (OLED) display, an active matrix liquid crystal display (AMLCD), or any other suitable device. Different client devices 110 may have display devices 210 with different characteristics. For example, different client devices 110 have display devices 210 with different display areas, different resolutions, or differences in other characteristics.

One or more input devices 205 included in the client device 110 receive input from the user. Different input devices 205 may be included in the client device 110. For example, the client device 205 includes a touch-sensitive display for receiving input data, commands, or information from a user. Using a touch-sensitive display allows the client device 110 to combine the display device 210 and an input device 205, simplifying user interaction with presented content items. In other embodiments, the client device 110 may include a keyboard, a trackpad, a mouse, or any other device capable of receiving input from a user. In another example, the input device 205 is configured to receive information from a user of the client device through a touchless interface. Examples of a touchless interface include sensors, such as an image capture device, to receive gestures from a client device user without the user physically contacting the display device 210 or the client device 110. Additionally, the client device 110 may include multiple input devices 205 in some embodiments. Inputs received via the input device 205 may be processed by a messaging application 215 executing on the client device 110 to allow a client device user to send messages or images to other client devices 110.

The data store 220 stores objects that each represent various types of content or data associated with applications executing on the client device 110, or various types of content interacted with by the user. Examples of content represented by an object include contact information such as a name, a phone number or email associated with one or more contacts associated with the user of the client device 110, images or videos captured using the camera of the client device 110, messages between the client device user and users (contacts on the device for example) of other client devices, or messages, images or videos associated with the messaging application 215. Client device users may create objects stored by the content store 110, such as contact information of other users or images captured using the client device 110. In one embodiment, the messaging application 215 interacts with or retrieves objects such as contact information stored in the data store 220.

The camera 225 includes one or more sensors to capture images and record video. The captured images and video may be stored in the data store 220 and may be accessed by the user of the client device 110. In one embodiment, an application such as the messaging application 215, executing on the client device 110 may access the sensors of the camera, via an API for example, to capture images and videos or present the environment currently being viewed by the sensors to the user via a user interface.

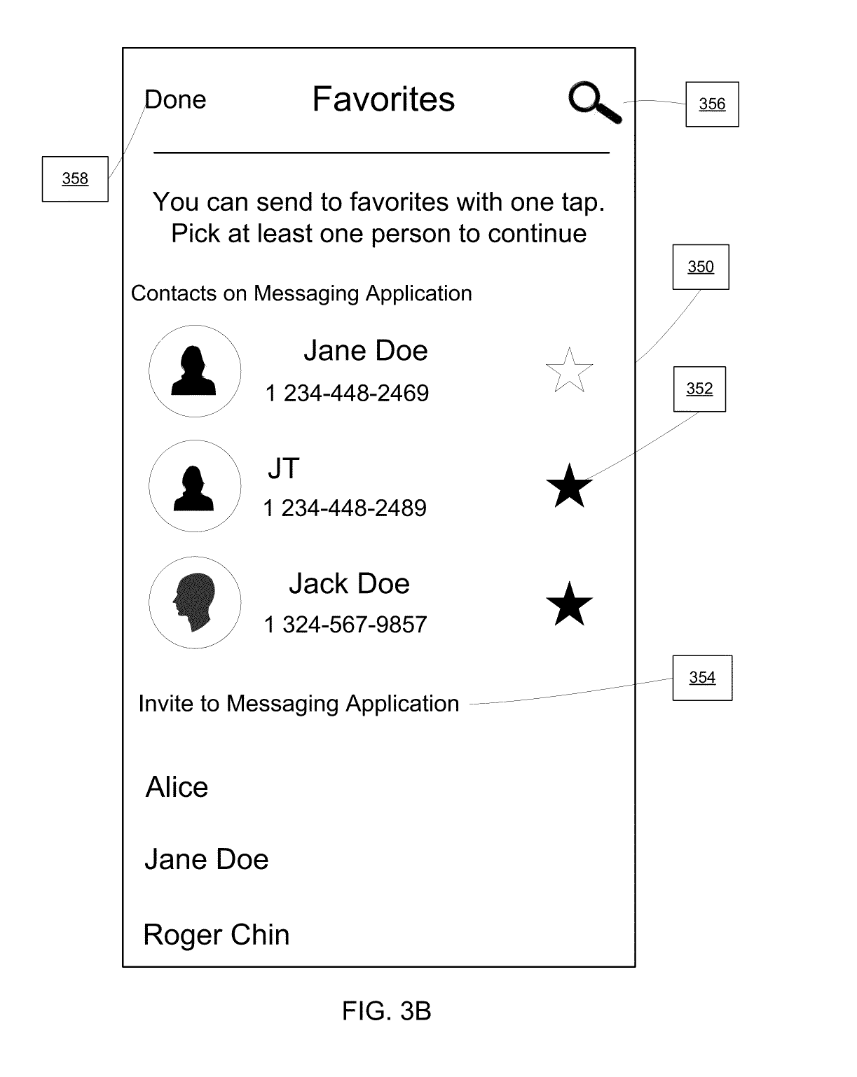

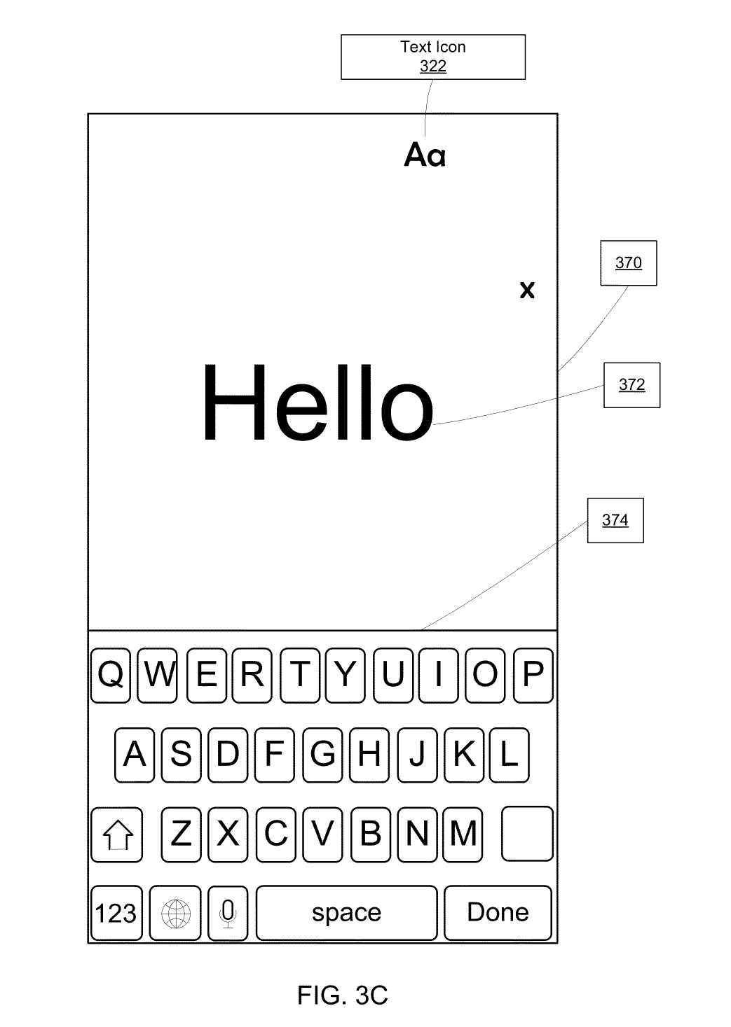

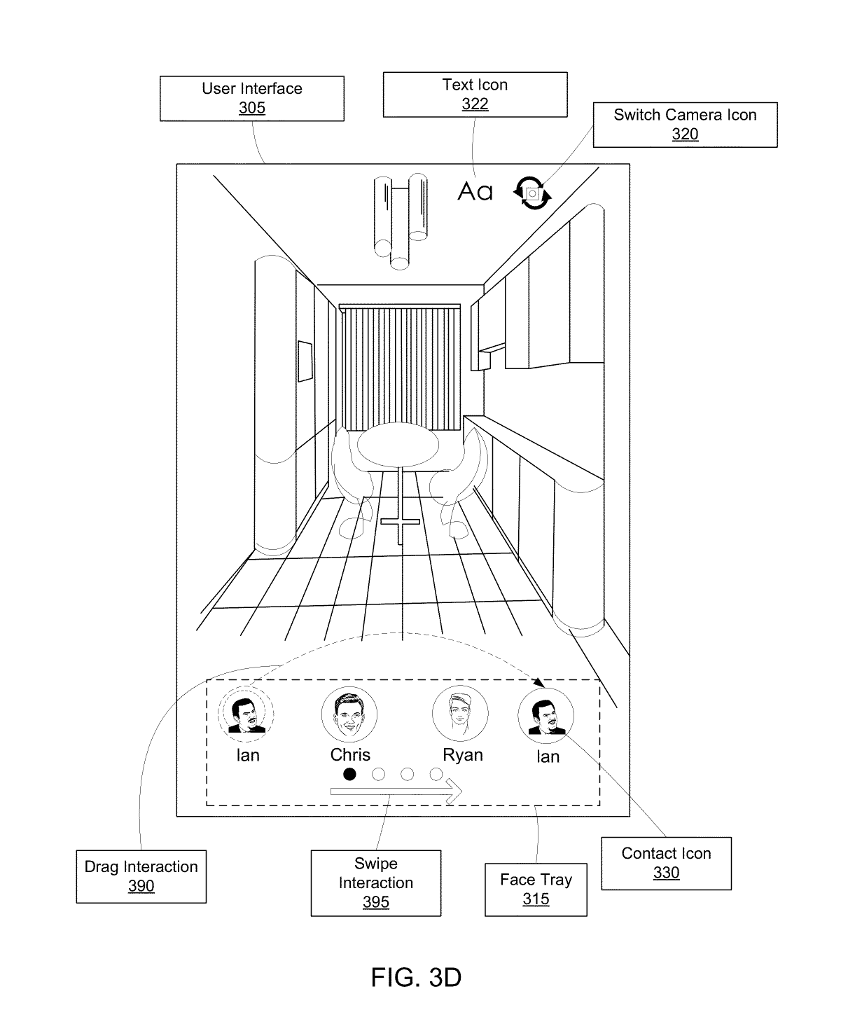

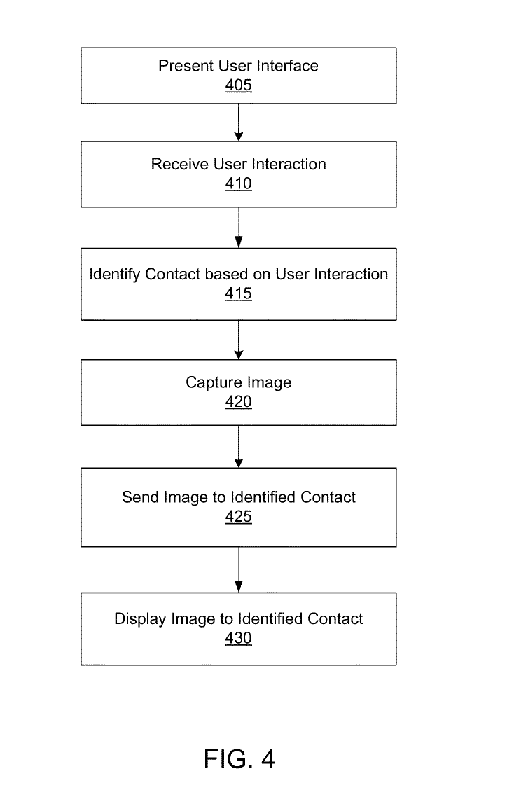

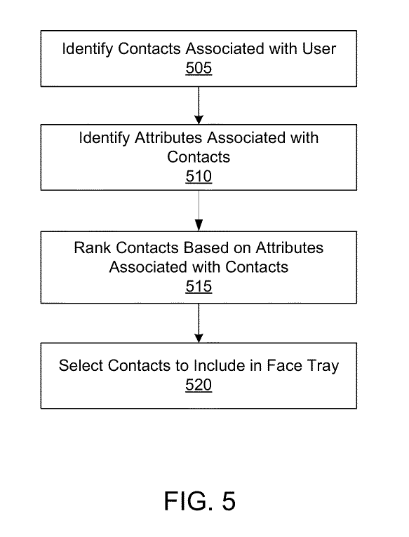

The messaging application 215 presents a user interface to the user to capture images and videos, and sends the captured images and videos to a contact or connection to the user, for example on receiving a single user interaction with the user interface, as described in greater detail in conjunction with FIG. 3A, FIG. 4, and FIG. 5 below. The messaging application 215 may interact with the camera 225, the input device 205, or display device 210, via an API for each component for example, to provide the user with a user interface including functionality to capture images or videos and send the captured images or videos to a contact identified by the user via a single user interaction for example. Various features of the user interface are described in greater detail in conjunction with FIG. 3A, 3B and 3C below. A user of the client device 110 may install the messaging application 215 on the client device 110 from one or more locations such as an application distribution platform (e.g., the APP STORE) or from a website associated with the messaging application 215.

### Example Messaging Application User Interface

FIG. 3A shows an example user interface presented to the user by the messaging application, according to one embodiment. The user interface 305 presented to the user via the display device 210 for example, allows the user, in one example, to capture an image and send the image to a contact or connection to the user on receiving a single user interaction. In the example of FIG. 3A the user interface 305 includes a face tray 315, one or more page icons 325, a camera view 330, a switch camera icon 320, an insert text icon 322, a gear icon 324, and a contact icon 330.

The camera view 330 includes a display of the current environment viewed by the camera 225. The current view of the environment viewed by the camera 225 as presented to the user of the client device 110 via the user interface 305 represents the image that will be captured by the messaging application 215 on receiving a user interaction from the user indicating that the user intends to capture the image presented to the user by the camera view 330. In one example, on being launched the messaging application 215 continuously captures a video stream, using the camera 225, and simultaneously presents the video stream to the user via the camera view 330 of the user interface 305. In one embodiment, the messaging application 215 may only present the camera view 330 to the user on receiving a user interaction 335 with a contact icon 330 displayed to the user via the face tray 315. In this embodiment, the camera view 330 represents the image captured by the user and sent to the contact associated with the contact icon 330 interacted with by the user.

The face tray 315, in one embodiment, is over laid over the camera view 330 and is presented to the user via the user interface 305. The face tray 315 includes one or more contact icons 330 and one or more page icons 325. The contact icons 330 represent contacts connected to the user to whom the user may capture and send an image or video via the user interface 305 provided by the messaging application 215. The contacts may be identified and retrieved from the data store 220 by the messaging application 215. In one example, the contacts connected to the user via the messaging application 215 and not included in the data store 220, and contact information associated with the contacts may be saved in the data store 220 by the messaging application 215. Each contact icon 330, in one embodiment, includes an image representing a contact, such as a default image or an image of the contact, and text identifying the first name, the last name, or nick name of the contact as defined by the user of the client device 110. Further, each contact icon 330 may include a graphic or feature such as an outline indicating the frequency with which the user has interacted with the contact icon. Examples of features include, a color of the outline of the contact icon, or the contact icon being animated based on the frequency with which the user has interacted with the contact icon over a threshold period of time. Each contact icon may also include an animated avatar that may become animated when the user interacts with the contact icon 330, or based on other factors such as the frequency with which the user interacts with the contact icons 330. Further, the messaging application 215 may cause the client device to play a sound, via a speaker for example, on receiving a user interaction with the contact icon 330.

Each page icon 325 represents a page displayed to the user, and each page contains a set of contact icons representing contacts associated with the user. In one example, only one page of the set of pages is presented to the user via the face tray 315 at any given time. In one embodiment, the page icons are bubbles or circular in shape, and the opaque bubble or colored in bubble is the bubble indicates the page currently being presented to the user. In the example of FIG. 3A, the first page of the set of page icons 325, represented by the first bubble being colored in or opaque, includes 4 contact icons representing contacts Ian, Chris, Ryan and Peter.

In one example, the contacts may be included in pages based on one or more attributes associated with contacts. For example, pages may be organized based on the relationship between the user and the contact icons included in the pages. For instance, the face tray 315 may include a family page including contact related to the user, a work page including contacts who work with the user, and a college friends page including contacts who went to college with the user. The user may select contact icons to include in pages and label pages via a user interface presented to the user. Alternatively, the user may drag icons to the edge of the face tray 315 to cause the face tray 315 to display the next page, and may then drop or release the icon on the next displayed page of the face tray to add the contact icon to that specific page of the face tray. In this manner, the user can select and change the position of contact icons in the face tray 315, as is discussed in more detail below regarding FIG. 3D.

In one embodiment, a contact icon 330 presented to the user via the face tray 315 includes a group of contacts with whom the user would like to communicate, or to whom the user would like to send an image or video. The user may create a group of contacts by selecting contacts to include in a group via user interface, by dragging a contact icon and placing it over another contact icon, thereby creating a group, or by dragging a contact icon to an already existing contact icon representing a group of contacts.

The user may interact with the page icons 325 to change the page or set of contacts being presented to the user via the face tray at any given time. In one example, the user could perform a swiping gesture across the face tray resulting in the next set of contact icons included in the next sequential page being displayed to the user, and the next sequential bubble being colored in or being made opaque. In this manner, the user can scroll through the faces in the face tray 315, as is discussed in more detail below regarding FIG. 3D. In another example, the user may select a bubble of the set of page icons 325 to cause the messaging application to display the contact icons associated with the respective page icon to the user via the face tray 315.

The messaging application may automatically populate the face tray and pages with contact icons associate with one or more contacts, as described in greater detail in conjunction with FIG. 5 below. Alternatively, the user may select one or more contacts to include in the face tray 315 using a user interface presented to the user by the messaging application 215, as described in conjunction with FIG. 3B below.

In one embodiment, the messaging application 215 automatically re-orders contact icons in the face tray 315 or on specific pages. For example, the messaging application 215 re-orders the contact icons in the face tray 315 based on a status of a communication between the user and a contact associated with the contact icon 330. The status of the communication between the user and a contact associated with a contact icon 330 refers to the status of whether the user sent the contact an image, whether the contact responded to or viewed the image or video sent to him or her from the user, whether the contact responded to a previous image or video sent to him or her by the user or whether the user recently received an image or video from the contact. The order in which the contacts are presented to the user may be based on whether the user sent the contact an image or video to view. The contact icons 330 associated with contacts that have been sent images may be organized to one side of the face tray 315 or on a different page of the face tray 315 than contacts that have not been sent an image or video. Similarly contact icons 330 may be automatically re-ordered based on whether the contacts associated with contact icons 330 that have been sent an image or video have viewed the image or video. Further, contact icons 330 associated with contacts who have responded to images or videos sent to them in the past may be automatically re-ordered in the face tray 315 by the messaging application 215. In another embodiment, the messaging application 215 may re-order the contact icons and differentiate the contact icons 330, by coloring the outline of the contact icons 330 for example, based on the status of communication between the user and the contacts associated with the contact icons 330.

FIG. 3B shows an example user interface for selecting one or more contacts to include in the face tray, according to one embodiment. The user interface 350 for selecting one or more contacts to include in the face tray 315 may include a variety of user interface elements, such as a favorite icon 352, contact icons 330, a search icon 356, and a done icon 358. In other embodiments, the user interface 350 may include more and/or different icons or user interface elements than those shown in FIG. 3B. The user interface 350 may be presented to the user when the user signs on to the application 215 for the first time or when the user interacts with an icon, such as the gear icon 324, presented to the user via user interface 305.

The favorite icon 352 (a star in example in FIG. 3B) when interacted with by the user may be used for selecting contacts connected to the user, such as ones who also use the messaging application 215, to include in the face tray 315. The contact icons 330 associated with contacts connected to the user may include text representing the name and contact information, such as a phone number identifying the contact. In one example, the contacts connected to the user who use the messaging application are displayed separately from those contacts who do not use the message application. The messaging application 215 allows the user to invite contacts associated with the user to install and use the messaging application on their client devices 110. The user, in one example, may interact with the contact names who do not have the messaging application 215, to invite the contacts associated with the contact names to install and use the messaging application 215 on their own client devices 110.

The done icon 358 when interacted with the user causes the messaging application 215 to save the selection of contacts to include in the face tray 215, such as by associating an identifier with the contacts selected to be included in the face tray 215, and closes user interface 350, and again presents user interface 305 of FIG. 3A to the user. The search icon 356 when interacted with by the user causes the messaging application 215, in one example, to present to the user a keyboard and an input field to receive a name of one or more contacts to be searched for an identified by the messaging application 215. On identifying the contact being searched for, the messaging application 215 may provide the user the option to invite the contact to use the messaging application 215 or may provide the user with the option to select the contact as a favorite to include in the face tray 315.

Returning to the description of FIG. 3A, the user may interact with the gear icon 324 to add contacts or contact icons 330 associated with contacts to the face tray 315. In one example, the messaging application 215 on receiving an interaction from the user presents the user with the user interface 350 described in conjunction with FIG. 3B. In another example, on receiving a user interaction with the gear icon 324, the messaging application 215 presents a contact store or set of contacts to the user from which the user may select one or more contact icons 330 to place in the face tray 315. In one embodiment, the contacts in the contact store are contacts who also use the messaging application 215, and are thus available to the user to add to the face tray 315 and communicate with using the messaging application 315. The contacts included in the contact store may be selected by the user to be included in the contact store on first launching the messaging application 215. Alternatively, the contacts in the contact store may be selected by the user via a user interface such as that described in conjunction with FIG. 3B above. The messaging application 215 may also automatically order and present contacts in the contact store to the user via a user interface using a method similar to that described in conjunction with FIG. 5 below. In one example, the user may drag a contact icon 330 from the contact store presented to the user and place the contact in the face tray 315. Similarly the user may adjust the position of contact icons 330 in the face tray 315 by dragging the contact icons to a different position in the face tray 315. The user may drag a contact icon 330 to the edge of the face tray 315 to display the next page of the face tray 315 including one or more contacts, thereby allowing the user to place and position contacts on a page of their choosing.

The switch camera icon 320, and the text icon 322 are also overlaid over the camera view 330 and are presented to the user via the user interface 305. The switch camera icon 320, when interacted with by the user, switches the camera view 330 viewed by the user from that viewed by a first camera on the client device 110 to that viewed by a second camera on the client device 110. For example, a client device 110 may have a forward facing camera and a backward facing camera. On receiving a user interaction with the switch camera icon 320 the messaging application may change the camera view 330 presented to the user from the view viewed by the first camera to that viewed by the second camera. The text icon 322 when interacted with by the user, in one example, results in the messaging application 215 providing the user with a user interface via which the user may overlay text over the camera view 330 presented to the user, such that the text is overlayed over the image captured by the messaging application 215 to send to a contact of the user, as described in conjunction with FIG. 3C below.

FIG. 3C shows an example user interface for entering text to be overlaid over the camera view presented to the user, according to one embodiment. The user interface 370 includes user interface elements for receiving text input from a user and overlaying the text input over the camera view presented to the user such that the text can be overlaid over an image captured by the user using the messaging application 215. The user interface 370 includes a text field 372, and a keyboard 374. The keyboard presented to the user includes keys representing letters as well as additional keys such as a spacebar key and a done key. On receiving a user interaction with different letters on the keyboard, the messaging application 215 populates the text field with the respective letters, thereby displaying to the user the letters to be overlaid over the camera view 330. On receiving an interaction with the done key, the done key, the messaging application presents user interface 205 to the user with the text input received from the user overlaid over the camera view 330 presented to the user. Though not shown in FIG. 3C, the user interface 370 may provide the user with additional user interface elements, such as those for changing the font of the text or changing the style attributes of the text.

Returning to the description of FIG. 3A, the user interface 305 may receive a user interaction with one or more icons or portions of the display device including one or more icons presented to the user via the user interface 305 from the user of the client device 110. Different user interactions and user interactions with different portions of the user interface 305 or icons of the user interface 305 result in the messaging application 215 performing different actions. For example, as shown in FIG. 3A, the messaging application 215 may receive a user interaction 335, such as a single tap or click, on the portion of the touch screen or display including a contact icon 330. The messaging application 215 may then capture the camera view 330 presented to the user when the massaging application 215 received the user interaction 335 as an image, and send the image to the contact associated with the contact icon 330 with which the user performed the user interaction 335. Thus, the messaging application 215 may send an image to a contact of the user on receiving a single interaction from the user with a contact icon 330 presented to the user via a face tray 315 included in the user interface 305 of the messaging application 215.

In another example, the messaging application 215 may receive a user interaction with a contact icon 330 presented to the user via the face tray 315 for greater than a threshold period of time. For example, a user may tap and hold, or place their finger for a prolonged period of time, on the portion of the user interface including a specific contact icon. Responsive to receiving a prolonged user interaction with a contact icon 330, the messaging application 215 captures a video including the camera view 330 presented to the user for the duration of the time of the user interaction, and sends the video to the contact associated with the contact icon 330 being interacted with by the user. For example, referring to FIG. 3A, the user may touch and hold the portion of the user interface 305 including a contact icon 330 associated with contact Ryan for 30 seconds. The messaging application 215 may then capture a video that is substantially 30 seconds long, including the camera view 330 that was presented to the user for the duration the user interacted with the contact icon, and send the captured video to the contact associated with the contact icon. Thus, a user may touch and hold the portion of the user interface 305 including a contact icon to capture a video and send the video to the contact associated with the contact icon using a single user interaction 335. In one embodiment, the messaging application 215 may execute one or more video stabilization algorithms in order to capture and/or generate a smooth, stable video to send to contacts of the user.

In one embodiment, the messaging application 215 may also monitor gestures made by the user using the client device 110 or on the client device 110 to determine one or more actions to be taken with respect to capturing images, sending images or saving images. For example, on performing a user interaction 335 with a contact icon 330 to capture and send an image, the user may then shake their smartphone (client device 110), to cause the messaging application 215 to save the image captured and sent on receiving the user interaction 335 from the user, in the data store 220 for example. In another example, the user may shake the client device 110 to undo or cancel an accidentally received user interaction with a contact icon resulting in the messaging application 215 accidentally capturing and sending an image to the contact associated with the contact icon. Given, that capturing and sending an image may be performed with a single user interaction received from the user, cancelling an accidentally captured image may also be beneficial. Apart from gestures, the user may also be provided with a user interface, in one embodiment, to prevent the messaging application 215 from accidentally capturing and sending an image. For example, the user may be provided with a user interface asking the using to confirm that the user intends to send the image captured by the user with the single user interaction.

In another embodiment, there may be additional icons presented to the user apart from those shown in the user interface 305 described with respect to FIG. 3B. For example, there may be a flash icon, which when interacted with by the user causes the messaging application 215 to enable the flash sensor for the next image to be captured using the messaging application 215. In another example, the user interface 305 may include a filter icon allowing the user to select one or more filters to be used while capturing the next image. The filters may be selected from a user interface presented to the user by the messaging application 215.

FIG. 3D shows example user interactions received from the user with respect to the face tray, in accordance with an embodiment of the invention. In the example, of FIG. 3D the user may perform a drag interaction 390 to manipulate or select the order in which the contact icons 330 are ordered in the face tray 315. For example, the user may perform the drag interaction 390 to drag the contact icon 330 labelled Ian from a first position in the face tray 315 to a second position in the face tray 315, thereby re-ordering the contact icons in the face tray 315. Similarly, the user may perform the drag interaction 390 to drag a contact icon 330 to the edge of the face tray 315 to display the next page of the face tray 315 including one or more contacts, thereby allowing the user to place and position contacts on a page of their choosing. As also explained above, the contact icons can also be automatically reordered based on the status of the message sent from or received from a contact icon (e.g., message sent, viewed, responded to). For example, in this case, the Ian icon may be moved automatically as shown in FIG. 3D to the other end of the face tray because Ian's message was responded to already by the user, and the Chris icon might move into the spot that Ian moved from because Chris' message is the next message that has not yet been responded to.

The user may also perform a swipe interaction 395 across the face tray 315 resulting in the next set of contact icons included in the next sequential page being displayed to the user, and the next sequential bubble being colored in or being made opaque. The swipe interaction 395 can also be used to scroll through the contact icons in the face tray 315 such that the faces at one end of the face tray scroll off the page one-by-one and additional faces at the other end of the face tray scroll onto the screen one-by-one. The swipe interaction 395 can be in either direction to scroll the face tray 315 right or left. As one example, the user might swipe her finger across the face tray 315 from left to right to move the left-most Ian contact icon right such that it takes the position occupied in the figure by the Chris contact icon, and thus a new contact icon scrolls onto the page to fill the current spot in the figure of the left-most Ian contact icon. Alternatively, the swipe from left to right might move all four of the contact icons off the page and swipe a new page of four new contact icons into view.

### Method For Capturing and Sending Images or Videos on Receiving a Single User Interaction

FIG. 4 is a flowchart illustrating a method for capturing images via a user interface according to one embodiment. The messaging application 215 presents 405 a user interface to the user to capture images and send the captured images to a contact or connection to the user, for example on receiving a single user interaction with the user interface. In one embodiment, the user interface presented to the user is similar to that described with respect to FIG. 3 above, in that it includes a face tray and additional icons overlaying input from the camera displaying the current view viewed by the camera's sensors.

The messaging application 215 receives 410 a user interaction associated with the user interface 305 presented to the user, from the user. For example, if the client device 110 has a touch display, the messaging application may receive a touch interaction from the user with one or more icons, such as a contact icon 330, presented to the user by the user interface 305. The user may interact with the portion of the display device 210 or input device 205 including a contact icon in the face tray 315, the contact icon representing a specific contact. In another example, the messaging application may receive an interaction with the portion of display including the text icon 322 or the switch camera icon 320, as described in conjunction with FIG. 3A above.

In one embodiment, on receiving a user interaction with a portion of the user interface 305 including a contact icon 330 within the face tray 315, the messaging application 215 identifies 415 the contact associated with the contact icon. For example, the messaging application 215 presents to the user via the face tray 4 contact icons. The user may interact with the first contact icon on the face tray intending to send the contact associated with the first contact icon an image representing the current camera view 330 viewed by the user. The messaging application 215 identifies 415 the contact associated with the first contact icon including additional information associated with the contact icon such as the phone number of the contact and name of the contact. The messaging application may retrieve an identifier associated with the contact icon interacted with by the user, and further retrieve contact information associated with the contact icon from the data store 220.

The messaging application 215 may then capture an image including the current view viewed by the camera as presented to the user via the camera view 330. The messaging application 215 may capture the image in a variety of file formats and in varying sizes or quality, for example in 1080p. In one example, the messaging application 215 while being used by the user, continuously captures a video stream, using the camera 225, and simultaneously presents the video stream to the user via the camera view 330 of the user interface 305. The captured video stream may be stored in the data store 220 for a threshold period of time, or a buffered portion of the captured video stream may be stored in the data store 220. On receiving a single user interaction with a contact icon in the face tray 315 of the user interface presented to the user, the messaging application 215 captures an image corresponding to the camera view 330 viewed by the user when interacting with the user interface 305, by retrieving the frame of the video stream corresponding to the time at which the user interaction was received by the user interface 305. The messaging application may identify the time associated with the interaction received from the user by executing one or more function calls associated with the operating system of the client device 110, the API of the display device 205, or the API of the input device 210. The messaging application 215 may also select from one or more frames within a threshold period of time associated with the received interaction based on the sharpness or image quality of the one or more frames. In another example, on receiving the user interaction with a contact icon in the face tray 315, the messaging application 215 executes a function call associated with the camera API instructing the camera to capture an image. The messaging application may store, permanently or temporarily the captured image in the data store 220.

The messaging application 215 then sends 425 the captured image to the identified contact. In one example, the messaging application 215 sends the captured image to the client device 110 associated with the identified contact over the network 120. In another example, the messaging application sends the captured image along with information identifying the identified contact, such as the name, the user name, the phone number, or the email associated with the identified contact to the messaging server 140. The messaging server 140 may then push the captured image to the messaging application executing on the client device 110 associated with the identified contact. In one embodiment, the messaging application 215 may modify the image such as change the size of the image file or the image quality prior to sending the image to the user.

In one embodiment, the messaging application 215 performs the operation of the sending of the image in the background, that is, while the application 215 continues to present the user interface 305 to the user, allowing the user to continue to capture images and videos and send the videos to contacts. Thus, the capturing and sending of an image appears immediate to the user, even though the sending may continue for a while in the background, and the user can still use the application 215 and does not have to wait for the application 215 to finish sending an image or video prior to capturing another image or video. This makes the user feel that the capturing and sending of images using the application 215 is a quick process.

In one embodiment, the messaging application 215 executing on the client device 110 associated with the identified contact 430, on receiving an image either from the messaging server or from another client device, displays the image 430 to be viewed by the identified contact. In one example, the image is displayed to the identified contact on receiving an interaction with a user interface element indicating that the identified contact has received a message or image to be viewed. In another example, the image is displayed to the identified contact when the messaging application 215 executing on the identified contact's client device is launched. The image displayed to the identified contact may be stored either permanently or temporarily in the data store 220 of the identified contact's client device 110. In one example, the image is deleted from the data store 220 and is no longer displayed to the identified contact on being displayed to the identified contact for more than a threshold period of time. In another embodiment, the image once displayed to or viewed by the identified contact is no longer accessible or available to be displayed again or viewed again by the identified contact via the messaging application 215 executing on the identified contact's client device 110. Further, the messaging application 215 may present to the identified contact a user interface along with the image. The user interface may include icons which when interacted with by the identified contact, may cause the messaging application 215 to capture an image to send back to the user, or receive text from the identified contact to send back to the user.

Similar to the identified contact not being able to save or view the images once the identified contact has viewed the image a first time, given the nature of the application 215 capturing and sending an image on receiving a single user interaction, the user too does not get the chance to review and approve the capturing and sending of an image or video. Thus, the application 215 is geared towards quickly capturing and sending images to contacts who may only view the image once before it is discarded. Hence, the application 215 facilitates the quick sharing of moments between users of the application 215, and does not focus on capturing perfect images of environments that are to be saved for prolonged amounts of time.

In other examples, the messaging application 215 executing on the client device may use a similar method to send videos captured by using the messaging application to contacts included in the face tray 315 of the user interface 305 on receiving a single user interaction from the user. For example, the images or videos may be sent to the contacts as a short message service (SMS) message, a multimedia service (MMS) message, an email or other forms of communication. In one example, the messaging application 215 may send an SMS to a contact of the user including a link via which the contact may access the image or video the user intended to send the contact.

### Ranking and Selecting Contacts to Include in the Face Tray of the User Interface Presented to the User

FIG. 5 is a flowchart illustrating a method for identifying and selecting contacts to include in the face tray of the user interface of the messaging application, according to one embodiment. The messaging application 215 presents a user interface to the user including a face tray. As described in conjunction with FIG. 3A the face tray 315 presented to the user includes one or more contact icons 330 representing contacts the user may send images and videos to via the messaging application 215. Thus, the messaging application generates a face tray 315 and populates the face tray 315 with contacts connected to the user to include in the user interface 305 presented to the user. The method described below, describes an embodiment for identifying and selecting contacts to populate the face tray 315 presented to the user. The method described below may also be used to identify, order and/or select contacts to include in the contact store presented to the user.

To populate the face tray with contact icons associated with contacts connected to the user, the messaging application 215 identifies 505 contacts associated with the user. The messaging application 215 may retrieve contact information associated with one or more contacts from the data store 220. In another embodiment, the messaging application 215 may receive contact information associated with one or more contacts from the user via a user interface provided to the user. In a third embodiment, the messaging application 215 retrieves contacts connected to the user and information associated with the contacts from the messaging server 140.

The messaging application 215 identifies 510 attributes associated with the contacts. Examples of attributes include the name of the contact, whether the contact also uses the messaging application 215, the number of times the user interacts with the contact via the messaging application 215 for example, or via other applications installed on the client device 110, such as a text messaging application or a calling application, address information associated with the contact, identifiers indicating the contact as a “favorite,” interactions with one or more contacts on a social networking system, or social networking system information in general.

The messaging application 215 then ranks 515 the contacts based on the attributes associated with the contacts. For example, contacts with last names similar to that of the user may be ranked higher than contacts who have different last names than the user. Contacts named as “mom,” “dad,” or “sister,” indicating a relationship between the user and the contact may be ranked higher than those contacts not named “mom,” “dad,” or “sister.” Contacts with last names, or with names inferring a relationship with a user are contacts the user may want to interact with more frequently. The messaging application 215 may identify names of contacts indicating a relationship across multiple languages, and rank the contacts based on the identified names. In another example, contacts assigned a nickname by the user may be ranked higher than those contacts not assigned a nickname by the user. Contacts having address information stored in the data store 220 may be ranked higher than those contacts without address information, as it is more likely that a user interacts more frequently with a contact with whom the user has made the effort to determine the address of the contact.

In another example, the messaging application 215 may rank the contacts based on the number of times the user has interacted with the contact using the messaging application 215 or other applications installed on the client device 110. For example, the messaging application 215 may rank contacts with which the user interacts frequently (e.g., more than a threshold number of times per time period, such as more than 5 times per day) using the messaging application 215 higher than those the contact interacts with less frequently. The messaging application may also rank contacts that the user interacts with frequently using other applications installed on the client device such as a texting application, or a calling application, higher than those contacts the user interacts with less frequently.

The messaging application 215 may rank contacts associated with one or more indicators identifying the contact as a “favorite,” or a contact the user intends to contact frequently higher than those contacts not including the one or more indicators. For example, contacts identified to be included in a quick-dial list may be ranked higher than those not included in a quick dial list stored in the data store 220. In another example, contacts with a custom ringtone selected by the user may be ranked higher than contacts without a custom ring tone, as contacts with a custom ring tone are often contacts the user would like to identify and are also contacts the user interacts with frequently. Further, contacts may be ranked based on the interactions between the user and the contacts on a social networking system (e.g., FACEBOOK®). For example, contacts with whom the user interacts with frequently via a social networking system application installed on the client device 110, may be ranked higher than those the user interacts with less frequently.

The messaging application 215 may rank contacts based on a social graph or clustering of connections between one or more contacts associated with the user. For example, the messaging server 140 receives a set of contacts associated with a user from the messaging application 215. The messaging server 140 may then identify connections between the contacts associated with the user. For example, the messaging server 140 may identify contacts associated with the user who have contacts included in the list of contacts associated with the user. The messaging server 140 may establish connections, and thus a social graph between the various contacts connected with each other or included in each other's address books. The contacts may then be ranked based on the number of connections between the user and each contact, for example.

In one embodiment, the contacts may be ranked based on inferred relationships between the user and the contacts based on the attributes associated with each contact. For example, a user of the messaging application 215 may be given a name such as “mom,” by a contact associated with the user in the list of contacts associated with the contact. The messaging server 140, may identify an inferred relationship between the contact and the user, and may rank the contact with the inferred relationship higher than other contacts.

The messaging application 215 may use a combination of the example ranking criteria described above to rank the contacts associated with the user.

The messaging application 215 then selects 520 contacts to include in the face tray presented to the user. In one embodiment, the messaging application 215 selects contacts based on the rank of the associated with the contacts. In another embodiment, the messaging application 215 may select a set of contacts based on the rank associated with the contacts to include in one or more pages to be presented via the page tray. For example, the messaging application 212 selects the top 4 ranked contacts to include in the first page to be displayed via the face tray 315, and the next 4 ranked contacts to include in the second page to be displayed via the face tray 315.

In one example, the selected 520 contacts are automatically added to the face tray presented to the user. In another example, the user is presented with a user interface including the selected 520 contacts or one or more ranked contacts from which the user may select one or more contacts to include in the face tray. Further, the messaging application 215 may present the selected 520 contacts or one or more ranked contacts for the user to select from, when the user first uses or signs on to the application 215, or when additional contacts, not previously interacted with by the user, become available for the user to interact with.

In one embodiment, the messaging application selects 520 contacts to include in the contact store presented to the user on receiving a user interaction with the gear icon of user interface 205, as described in conjunction with FIG. 3A above. Alternatively, the messaging application may order the contacts in the contact store based on the rank associated with the contacts. For example, contacts with a higher ranking are placed higher in the order of contacts presented to the user. This is particularly beneficial as the user is presented with contacts the user is more likely to be interested in interacting with first or at the top of the list of contacts presented to the user, thereby saving the user time that the user may have spent searching for the contacts the user is interested in interacting with by scrolling through the list of contacts in the contact store.

### CONCLUSION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer program product comprising a computer-readable medium having instructions encoded thereon that, when executed by a processor, cause the processor to:
present a user interface to a user of a client device, the user interface comprising a face tray that includes a plurality of contact icons, each contact icon representing one or more contacts of the user;
receive a single user interaction with a selected contact icon of the plurality of contact icons included in the face tray; and
responsive to receiving the single user interaction:
capture an image using a camera on the client device,
identify the contact represented by the selected contact icon, and
send the captured image to the identified contact.

2. The computer program product of claim 1, wherein the user interface further includes a camera view representing the view currently viewed by the camera of the client device, and wherein the face tray is an overlay on the camera view.

3. The computer program product of claim 2, wherein the user interface further includes a switch camera icon, the switch camera icon when interacted with by the user, changes the camera view from that currently viewed by a first camera on the client device to that currently viewed by a second camera on the client device.

4. The computer program product of claim 1, wherein the user interface further comprises a text icon, and wherein the instructions further cause the processor to:
present a second user interface to the user responsive to receiving a user interaction with the text icon, the second user interface comprising a keyboard, and a text field, the text field displaying text content representing user input received via the keyboard displayed to the user.

5. The computer program product of claim 1, wherein capture an image comprises:
receive a video stream via the camera on the client device;
identify a frame of the video stream corresponding to the time at which the user interaction was received; and
save the identified frame as an image.

6. The computer program product of claim 1, wherein send the captured image to the identified contact comprises:
retrieve contact information associated with the identified contact; and
send the captured image via a network or a messaging server to the identified contact associated with the contact information.

7. The computer program product of claim 1, wherein a contact icon of the plurality of contact icons represents a group of users, and wherein the instructions further cause the processor to, responsive to receiving a single user interaction with the contact icon:
capture an image using a camera on the client device;
identify the contacts in the group of contacts represented by the contact icon; and
send the captured image to the identified contacts in the group of contacts.

8. The computer program product of claim 1, wherein the user interface further comprises a gear icon, and wherein the instructions further cause the processor to:
present a third user interface to the user, responsive to receiving a user interaction with the gear icon, the third user interface comprising contacts the user may select to include in the face tray.

9. The computer program product of claim 8, wherein a contact in the face tray is selectable by the user to include in the face tray by dragging of a contact icon associated with the contact from the third user interface to the face tray.

10. The computer program product of claim 1, wherein the image is sent to the identified contact without receiving a confirmation from the user or without presenting the captured image to be reviewed by the user prior to sending.

11. The computer program product of claim 1, wherein the instructions further cause the processor to:
receive a gesture; and
responsive to receiving the gesture, cancel the sending of the captured image to the identified contact.

12. The computer program product of claim 1, wherein the instructions further cause the processor to:
receive a gesture; and
responsive to receiving the gesture, store the captured image sent to the identified contact on the client device.

13. The computer program product of claim 1, wherein the instructions further cause the processor to allow the user to continue to interact with the user interface as the sending of the captured image to the identified contact occurs.

14. The computer program product of claim 1, wherein the instructions further cause the processor to:
receive a user interaction with the face tray; and
responsive to receiving the user interaction with the face tray, present different contact icons to the user.

15. A computer program product comprising a computer-readable medium having instructions encoded thereon that, when executed by a processor, cause the processor to:
present a user interface to a user of a client device, the user interface comprising a plurality of contact icons, each contact icon representing one or more contacts of the user;
receive a single user interaction with a selected contact icon of the plurality of contact icons, the single user interaction lasting for a threshold period of time; and
responsive to receiving the single user interaction:
capturing a video using a camera on the client device during the threshold period of time,
identifying the contact represented by the selected contact icon, and
sending, the captured video to the identified contact.

16. The computer program product of claim 15, wherein the user interface further includes a camera view representing the view currently viewed by the camera of the client device, and wherein the face tray is an overlay on the camera view.

17. The computer program product of claim 16, wherein the user interface further includes a switch camera icon, the switch camera icon when interacted with by the user, changes the camera view from that currently viewed by a first camera on the client device to that currently viewed by a second camera on the client device.

18. The computer program product of claim 15, wherein the user interface further comprises a text icon, and wherein the instructions further cause the processor to:
present a second user interface to the user responsive to receiving a user interaction with the text icon, the second user interface comprising a keyboard, and a text field, the text field displaying text content representing user input received via the keyboard displayed to the user.

19. The computer program product of claim 15, wherein send the captured video to the identified contact comprises:
retrieve contact information associated with the identified contact; and
send the captured video via a network or a messaging server to the identified contact associated with the contact information.

20. The computer program product of claim 15, wherein a contact icon of the plurality of contact icons represents a group of users, and wherein the instructions further cause the processor to, responsive to receiving a single user interaction with the contact icon:
capture a video using a camera on the client device for the threshold period of time;
identify the contacts in the group of contacts represented by the contact icon; and
send the captured video to the identified contacts in the group of contacts.

21. The computer program product of claim 15, wherein the user interface further comprises a gear icon, and wherein the instructions further cause the processor to:
present a third user interface to the user, responsive to receiving a user interaction with the gear icon, the third user interface comprising contacts the user may select to include in the face tray.

22. The computer program product of claim 21, wherein a contact in the face tray is selectable by the user to include in the face tray by dragging of a contact icon associated with the contact from the third user interface to the face tray.

23. The computer program product of claim 15, wherein the captured video is sent to the identified contact without receiving a confirmation from the user or without presenting the captured video to be reviewed by the user prior to sending.

24. The computer program product of claim 15, wherein the instructions further cause the processor to:
receive a gesture; and
responsive to receiving the gesture, cancel the sending of the captured video to the identified contact.

25. The computer program product of claim 15, wherein the instructions further cause the processor to:
receive a gesture; and
responsive, to receiving the gesture, storing the captured video sent to the identified contact on the client device.

26. The computer program product of claim 15, wherein the instructions further cause the processor to allow the user to continue to interact with the user interface as the sending of the captured video to the identified contact occurs.

27. The computer program product of claim 15, wherein the instructions further cause the processor to:
receive a user interaction with the face tray; and
responsive, to receiving the user interaction with the face tray, present different contact icons to the user.
